(19) United States
(12) Patent Application Publication
(10) Pub. No.: US 2024/0165836 A1
(43) Pub. Date: May 23, 2024

(54) ERGONOMIC SCISSORS AND SHEARS

(71) Applicant: Instant Brands Holdings Inc., Downers Grove, IL (US)

(72) Inventors: Michael Sean Run, Chicago, IL (US); Tania Louise Aldous, Niles, IL (US)

(21) Appl. No.: 18/058,574

(22) Filed: Nov. 23, 2022

(51) Int. Cl. B26B 13/20

(52) U.S. Cl. CPC B26B 13/20

(57) ABSTRACT

A pair of ergonomic scissors and shears are provided. The pair of scissors comprising a first blade and a second blade pivotally connected by a coupler. The first blade coupled to a thumb loop and the second blade coupled to a finger loop. The thumb loop including a first grip extending about an inner ring of the thumb loop and the finger loop including a second grip extending about an inner ring of the finger loop. The pair of scissors further including a third grip extending at least partially along a first side of the finger loop and including a plurality of protrusions and a third grip extending at least partially along a neck formed between the finger loop and the second blade. The first gripping element, the second gripping element, and the third gripping element formed from a gripping material and overmolded on the respective thumb loop and finger loop.

### FIELD

The present application relates to the field of hand tools including hand tools designed for cutting materials, such as scissors and shears.

### BACKGROUND

Scissors and shears are widely used for cutting materials. However current scissors and shears are not without their disadvantages. One such disadvantage of scissors and shears available on the market today is that they are generally viewed as being utilitarian in nature so important ergonomic features that would make a user's experience comfortable and more effective are often ignored when designing such scissors and shears.

The ability to cut through a material with a pair of scissors or shears depends on a variety of factors, including, e.g., the sharpness of the blades on the scissors or shears and the ability of the user to keep the scissors or shears at the desired angle (e.g., perpendicular) to the material being cut. Other factors impacting the performance of scissors or shears typically include the ability of the user to apply a downward and/or upward force towards the material to be cut and the ability of the user to apply a lateral force in a direction toward the material being cut.

To improve many of the above factors, it would be advantageous to have a pair of scissors or shears that incorporate ergonomic features into the body of the scissors or shears to maximize a user's ability to grip the scissors or shears, exert downward, upward, and lateral force on the material being cut to minimize the time and effort it takes to cut the material using the scissors and shears, and/or to provide a user both stability and control while using the scissors or shears.

### BRIEF DESCRIPTION OF THE DRAWINGS

Disclosed herein are embodiments of systems and apparatus pertaining to a pair of ergonomic scissors and shears. The description includes drawings, wherein:

FIG. 1 is a side elevation view of one embodiment of a pair of scissors;

FIG. 2 is a side elevation view of the pair of scissors of FIG. 1 showing the side opposite of the side shown in FIG. 1;

FIG. 3 is a top plan view of the pair of scissors shown in FIG. 1;

FIG. 4 is a bottom plan view of the pair of scissors shown in FIG. 1;

FIG. 5 is a cross-section side view of the pair of scissors shown in FIG. 1;

FIG. 6 is a cross-section side view of the pair of scissors shown in FIG. 1 showing the side opposite shown in FIG. 5;

FIG. 7 is a side elevation view of another embodiment of a pair of scissors;

FIG. 8 is a side elevation view of the pair of scissors of FIG. 7 showing the side opposite of the side shown in FIG. 7;

FIG. 9 is a top plan view of the pair of scissors shown in FIG. 7;

FIG. 10 is a bottom plan view of the pair of scissors shown in FIG. 7;

FIG. 11 is a cross-section side view of the pair of scissors shown in FIG. 7;

FIG. 12 is a cross-section side view of the pair of scissors shown in FIG. 7 showing the side opposite shown in FIG. 11;

FIG. 13 is a side elevation view of another embodiment of a pair of scissors;

FIG. 14 is a side elevation view of the pair of scissors of FIG. 13 showing the side opposite of the side shown in FIG. 13;

FIG. 15 is a top plan view of the pair of scissors shown in FIG. 13;

FIG. 16 is a bottom plan view of the pair of scissors shown in FIG. 13;

FIG. 17 is a cross-section side view of the pair of scissors shown in FIG. 13; and

FIG. 18 is a cross-section side view of the pair of scissors shown in FIG. 13 showing the side opposite shown in FIG. 17;

FIG. 19 is a side elevation view of another embodiment of a pair of scissors according to one aspect of the present application;

FIG. 20 is a side elevation view of the pair of scissors of FIG. 19 showing the side opposite of the side shown in FIG. 19;

FIG. 21 is a top plan view of the pair of scissors shown in FIG. 19;

FIG. 22 is a bottom plan view of the pair of scissors shown in FIG. 19;

FIG. 23 is a cross-section side view of the pair of scissors shown in FIG. 19; and

FIG. 24 is a cross-section side view of the pair of scissors shown in FIG. 19 showing the side opposite shown in FIG. 23.

While the present application discloses certain preferred embodiments, there is no intent to limit it to those embodiments. On the contrary, the intent is to cover all alternatives, modifications and equivalents as included within the spirit and scope of the disclosure made in the present application as defined by the appended claims.

### DETAILED DESCRIPTION

Generally speaking, scissors and shears are provided having a first blade and a second blade pivotally connected by a coupler, where the first blade is coupled to a thumb loop and the second blade is coupled to a finger loop. In one illustrative configuration, the thumb loop includes a first grip or gripping element extending about an inner ring of the thumb loop and the finger loop includes a second grip or gripping element extending about an inner ring of the finger loop.

In another aspect, a pair of scissors or shears may include a third grip or gripping element extending at least partially along a first side of the finger loop. By some approaches, the third gripping element includes a plurality of protrusions.

In still yet another aspect, a pair of scissors or shears includes a fourth grip or gripping element extending at least partially along a neck formed between the second blade and the finger loop. By some approaches, the fourth gripping element includes a surface having a plurality of fins interspersed between a plurality of gullies.

In some configurations, a pair of scissors or shears includes a thumb loop with a first side and a second side opposite the first side with an inner ring extending therebetween, where the inner ring of the thumb loop may be tapered between the first side and the second side thereof, such that an opening through the thumb loop is larger on the first side of the thumb loop than on the second side of the thumb loop.

By some approaches, a pair of scissors and shears may include a finger loop with a generally oblong shape. In some embodiments, the inner ring of the finger loop includes a first finger rest having a generally curved surface. Further, in some configurations, the scissors or shears may include a second finger rest having a generally curved surface that is located adjacent to a top surface of the finger loop. The inner ring of the finger loop may further include a first generally straight surface and a second generally straight surface that meet at a lowermost generally curved surface to form an angle that is located adjacent to a bottom surface of the finger loop.

In another configuration, a pair of scissors and shears may include an angle formed between the first generally straight surface and the second generally straight surface is greater than 90° and less than 180°.

The term scissors and shears are used interchangeably herein, with either term being meant to encompass any cutting tool, implement, or instrument used for cutting any material.

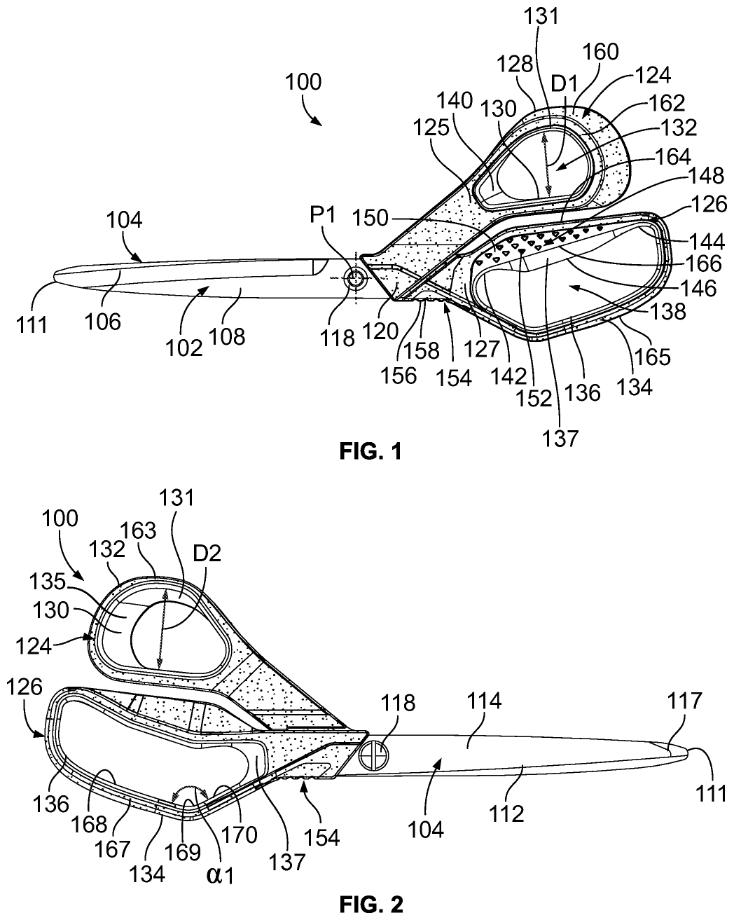

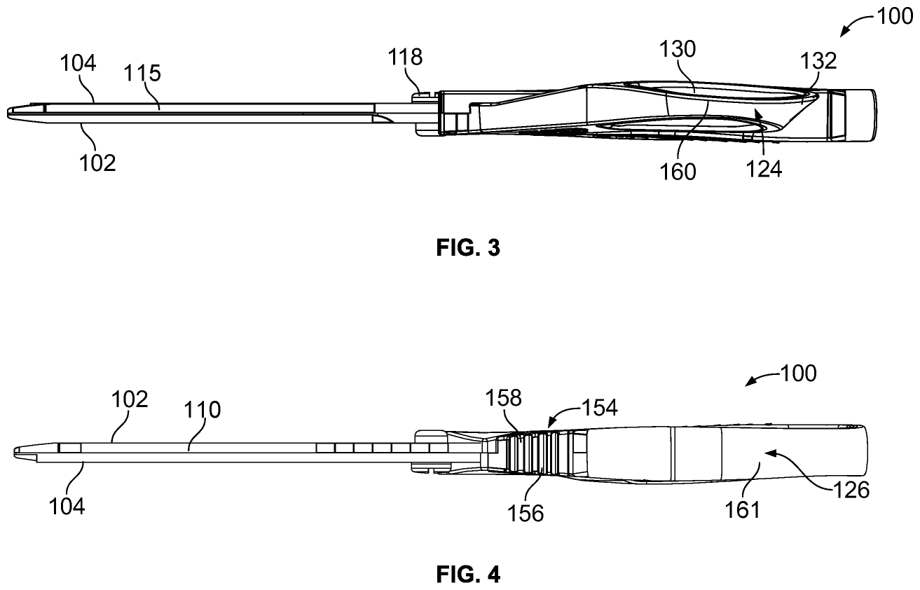

FIGS. 1-6 illustrate one embodiment of a pair of scissors 100 according to one aspect of the present application. As shown, the scissors include a first blade 102 and a second blade 104. The first blade 102 includes a cutting edge 106, a blade wall 108, a backside 110 and a tip 111. Similarly, the second blade 104 includes a cutting edge 112, a blade wall 114, a backside 115 and a tip 117. The first blade 102 and the second blade 104 are pivotally coupled together at pivot point P1 via a coupling mechanism 118, such as, but not limited to a tension knob, tension dial, rivet, or a screw.

In one approach, the first blade 102 and the second blade 104 can be formed of a metal material. For example, the metal material can be a Steel, a Stainless Steel, a Carbon Steel, a Zinc Alloy, a Gray Iron, a White Iron, a Ductile Iron, a Copper-Based Alloy, a Nickel-Based Alloy, an Aluminum Alloy, a Magnesium, a Zinc, a Tin and/or a Lead.

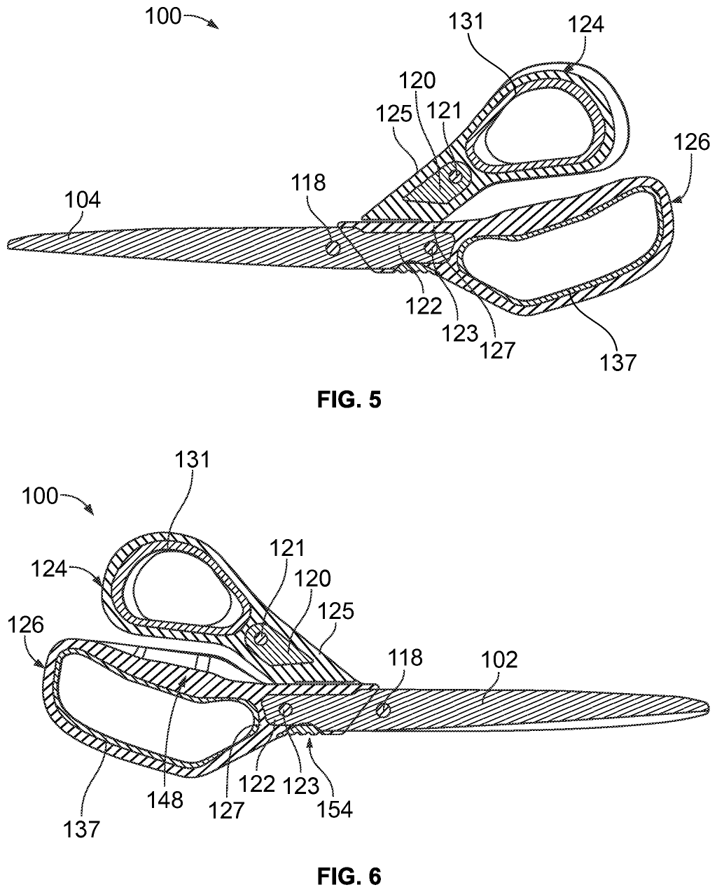

The first blade 102 has a first shank 120 and the second blade 104 has a second shank 122. As shown in FIGS. 5 and 6, the first shank 120 includes a first opening or coupling notch 121 configured to facilitate a thumb loop 124 being securely coupled with the first blade 102 and the second shank 122 including a second opening or notch 123 configured to facilitate a finger loop 126 being securely coupled with the second blade 104.

In one approach, the thumb loop 124 is coupled to the first blade 102 by overmolding the thumb loop 124 onto the first shank 120 and having the overmolded material extend in, around, and/or through the opening or first coupling notch 121. Likewise, the finger loop 126 is securely coupled to the second blade 104 by overmolding the finger loop 126 on the second shank 122 and having overmolded material extend in, around, and/or through the opening or second coupling notch 123.

The overmolding of the thumb loop 124 on the first coupling notch 121 will create a first neck portion 125 that extends between the thumb loop 124 and the first blade 102, such that the thumb loop 124 is securely coupled with the first blade 102. Likewise, the overmolding of the finger loop 126 on the second coupling notch 123 will create a second neck portion 127 that extends between the finger loop 126 and the second blade 104, such that the finger loop 126 is securely coupled with the second blade 104.

In one approach, the overmolding used to form the thumb loop 124 and the finger loop 126 can be a plastic material. For example, the plastic material used to overmold the thumb loop 124 and the finger loop 126 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

The thumb loop 124 further includes a top 160, a bottom 161, a first side 162, and a second side 163 that is opposite the first side 162. Likewise, the finger loop 126 includes a top 164, a bottom 165, a first side 166, and a second side 167 that is opposite the first side 166.

Returning to FIG. 1, the thumb loop 124 further including an outer ring 128 and an inner ring 130 with the inner ring 130 defining an opening 132 through the thumb loop 124 that is configured to receive the thumb of a user. The finger loop 126 also including an outer ring 134 and an inner ring 136 with the inner ring 136 defining an opening 138 through the finger loop 126 that is configured to receive one or more fingers of a user.

In one illustrative embodiment, the inner ring 130 of the thumb loop 124 includes a first grip or gripping element 131 that extends about or over at least portions of the inner ring 130 of the thumb loop 124. In some configurations, the inner ring 136 of the finger loop 126 includes a second grip or gripping element 137 that extends about or over at least portions of the inner ring 136 of the finger loop 126. By some approaches, the first gripping element 131 and the second gripping element 137 are formed of a gripping material that provides increased leverage, traction, or grip to a user's thumb and one or more fingers as they engage with the respective inner rings 130, 136 of the thumb loop 124 and finger loop 126. In some configurations, the gripping material also may have properties of flexibility and elasticity that may make the thumb loop 124 and the finger loop 126 more comfortable for the user to repeatedly manually manipulate.

In one approach, the gripping material of the first gripping element 131 and the second gripping element 137 can be comprised of a second plastic material that is overmolded directly on the first plastic material that makes the thumb loop 124 and the finger loop 126 as discussed above. According to another approach, the second plastic that makes up the gripping material of the first gripping element 131 and the second gripping element 137 may be a Thermoplastic Elastomer (TPE) or a Thermoplastic Rubber (TPR).

The opening 132 defined by the inner ring 130 of the thumb loop 124 may have a generally oblong shape. The inner ring 130 of the thumb loop 124 also may be tapered and/or angled between its first side 162 and second side 163. By one approach, the opening 132 through the thumb loop 124 has diameter D1 that is smaller on the first side 162 of the thumb loop 124 than a diameter D2 of the opening 132 on the second side 163 of the thumb loop 124. In some embodiments, the walls of the opening forming the inner ring 130 are angled toward the tip 111 of the first blade 102.

In one illustrative embodiment, in light of the diameter D1 being smaller than the diameter D2, the inner ring 130 has a natural incline or slope as it extends between the second side 163 to the first side 162 of the thumb loop 124. As will be discussed further below, the natural incline or slope of the inner ring 130 provides users with ergonomic benefits over thumb loops on currently available scissor and shears. For example, a user's thumb typically has a greater range of motion when it is inserted through the thumb loop 124 when compared to thumb loops found on traditional scissors. This, in turn, provides the user not only additional comfort, but also the ability to apply more downward force on the thumb loop 124 compared to currently available thumb loops. For example, the greater range of motion allows a user to rotate their thumb within the thumb loop 124 so that the middle portion of their thumb can apply greater downward force on the first side 162 of the thumb loop 124 than would be possible on available scissors and shears. Likewise, the greater range of motion also allows the user to rotate their thumb within the thumb loop 124 so that the base portion of their thumb can apply greater downward force on the second side 163 of the thumb loop 124 than would be possible on scissors and shears currently on the market.

As will be appreciated, angling and/or tapering the inner ring 130 of the thumb loop 124 (e.g., disposing the opening 132 such that the first side 162 of the thumb loop 124 is smaller than the diameter of the second side 163 of the thumb loop 124 and/or angling the walls of the opening such that the second side 163 of the opening is disposed rearward of the first side 162) provides a first thumb rest 135 on the inner ring 130 of the thumb loop 124. The first thumb rest 135 provides the user's thumb with the ergonomic benefit of a greater range of motion when the user's thumb is inserted into the thumb loop 124. In addition to the obvious comfort benefit that comes with a greater range of motion, the first thumb rest 135 also allows the user to cut through thicker materials with greater ease than would be possible with the thumb loops on currently available scissors and shears. The thumb rest 135 does this by providing greater clearance for the base of a user's thumb to rotate inwardly toward the second side 163 of the thumb loop 124. This, in turn, allows the base of the user's thumb to apply greater downward force on the second side 163 of the thumb loop 124 than would be possible with the thumb loops found on traditional scissors and shears. In addition, the first thumb rest 135 also provides a surface for the back of a user's thumb to rest against when the scissors 100 are in use.

The angling and/or tapering of the inner ring 130 of the thumb loop 124 also provides a second thumb rest 140 on the thumb loop 124 that provides additional clearance for the middle portion of user's thumb to rotate inwardly toward the first side 162 of the thumb loop 124 when the user is applying a downward force on the thumb loop 124 to bring the first blade 102 and the second blade 104 together, such as when the user is bringing the first blade 102 and the second blade 104 together to cut a piece of material.

As with the first thumb rest 135 discussed above, the clearance provided by the second thumb rest 140 allows for greater rotation of the middle portion of a user's thumb toward the first side 162 of the thumb loop 124 than would be possible with the thumb loops found on currently available scissors and shears. This, in turn, allows the middle portion of the user's thumb to apply greater downward force on the first side 162 of the thumb loop 124 than would be possible with the scissors and shears currently available on the market. Thus, the second thumb rest 140 not only provides the user with the obvious ergonomic benefits that come with having a greater range of motion, but it also allows a user to cut through thicker pieces of materials with greater ease than would be possible with the thumb loops used on currently available scissors and shears.

In some embodiments, the finger loop 126 also includes a third grip or gripping element 148 that extends at least partially along the first side of the 166 of the finger loop 126. As shown, the third gripping element 148 includes a textured surface or patter facilitating an increase of friction between the finger loop 126 and a user's fingers when the user is grasping the finger loop 126.

In one approach, the third gripping element148 has a surface 150, which may be generally smooth, and further includes a plurality of discrete protrusions 152 disposed thereon. The plurality of discrete protrusions 152 may be, but are not required to be, uniformly spaced out along the surface 150 of the third gripping element 148. The plurality of discrete protrusions 152 may be any shape generally known in the art, such as, but not limited to being triangular in shape. In one illustrative approach, the discrete protrusions have a tactile aspect that may inform the user of where and how the scissors 100 are configured relative to the user's hand. In this manner, the user may be able to more effectively and efficiently adjust or manipulate the cutting tool by relying on manual feel of or feedback from the tool as opposed to a visual inspection thereof.

In one approach, the gripping material of the third gripping element 148 can be formed of a second plastic material that is overmolded directly on the first plastic material that makes the finger loop 126, as discussed above. According to another approach, the second plastic material that makes up the gripping material of the third gripping element 148 may be comprised of a Thermoplastic Elastomer (TPE) or a Thermoplastic Rubber (TPR).

In yet another approach, the third gripping element 148 can be formed during the same overmolding process that forms the second gripping element137 that extends about the inner ring 136 of the finger loop 126, such that the third gripping element 148 and the second gripping element 137 are formed from the same continuous piece of gripping material.

In still yet another approach, the third gripping element 148 can be formed separate from the second gripping element 137 that extends about the inner ring 136 of the finger loop 126, such that the third gripping element 148 and the second gripping element 137 are formed from separate or non-continuous pieces of gripping material.

In some embodiments, the finger loop 126 also includes a fourth grip or gripping element 154 that is located on the bottom side 165 of the finger loop 126 and more specifically on the second neck portion 127 formed between the second blade 104 and the finger loop 126. By some approaches, the fourth gripping element 154 includes a plurality of ridges or fins 156 interspersed between a plurality of notches, depressions, or gullies 158. As disposed, the fourth gripping element 154 provides a gripping surface fora user to place their pointer finger when grasping the finger loop 126 with one or more of their middle finger, ring finger, or pinky finger. In use, this may increase or improve responsiveness and manipulation of the scissors.

For example, when a user places their pointer finger on the fourth gripping element 154 while using the scissors 100 it provides a means for the user to stabilize the direction that the respective blades 102, 104 of the scissors are pointing when cutting a material as well as providing an additional means to apply an upward force on the second blade 104 of the scissors 100 when bringing the first blade 102 and the second blade 104 together to cut a piece of material.

In one approach, the fourth gripping element 154 can be formed from a plastic material. For example, the plastic material used to form the fourth gripping element 154 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

In another approach, the fourth gripping element 154 can be formed during the same overmolding process that forms the finger loop 126, such that the fourth gripping element 154 and the finger loop 126 are formed from the same piece of plastic material.

In another approach, the fourth gripping element 154 can be formed separate from the finger loop 126, such that the fourth gripping element 154 and the finger loop 126 are not formed during the same overmolding process and are formed from separate or non-continuous pieces of plastic material.

In still yet another approach, the fourth gripping element 154 can be formed from a gripping material, such as a second plastic material that is overmolded directly on the first plastic material used to make the finger loop 126 as discussed above. According to another approach, the second plastic material used to make the fourth gripping element 154 can be a Thermoplastic Elastomer (TPE) or a Thermoplastic Rubber (TPR).

In another approach, the gripping material of the first gripping element 131, the second gripping element 137, the third gripping element 148, and the fourth gripping element 154 can be comprised of a polymer material such as a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

A further ergonomic feature of the scissors 100 is the shape of the opening 138 of the finger loop 126 that is defined by a wall or surface of the inner ring 136 of the finger loop 126. In one illustrative configuration, the inner ring 136 of the finger loop 126 located adjacent to the top 164 of the finger loop 126 has a first finger rest 142 having a generally curved shape and a second finger rest 144 having generally curved shape. In addition, the inner ring 136 also may have a third finger rest 146. In some embodiments, the third finger rest 146 has a portion thereof that is generally linear or flat shaped extending between the first and second finger rests 142, 144.

As will be appreciated, the first finger rest 142 with a generally curved shape is configured to receive a user's frontmost finger that is placed within the finger loop 126, such as, but not limited to a user's pointer finger or middle finger and the second finger rest 144 with a generally curved shape is configured to receive a user's rearmost finger that is placed within the finger loop 126, such as, but not limited to a user's pinky finger or ring finger.

As will be appreciated, the first finger rest 142 provides the ergonomic benefit of stabilizing a user's frontmost finger when the user is grasping the finger loop 126 and applying an upward force on the finger loop 126 when bringing the finger loop 126 and the thumb loop 124 together, such as when cutting a piece of material. Likewise, the second finger rest 144 also provides the ergonomic benefit of stabilizing a user's rearmost finger when the user is grasping the finger loop 126 and applying an upward force on the finger loop 126 when bringing the finger loop 126 and the thumb loop 124 together, such as when cutting a piece of material.

In addition, the first finger rest 142 and the second finger rest 144 provide additional clearance within the finger loop 126, such that a user may grasp the finger loop 126 with one or more additional fingers compared to a finger loop on a traditional pair of scissors. As will be appreciated, being able to grasp the finger loop 126 with one or more additional fingers gives the user more stability or control over the scissors 100 and allows the user to apply additional upward finger force on the finger loop 126 when brining the finger loop 126 and the thumb loop 124 together, such as when a user is cutting a piece of material with the scissors 100.

Further, the third finger rest 146 disposed between the first and second finger rests 142, 144 is generally elongated and linear or flat shaped. By one approach the third finger rest 146 extends between the first finger rest 142 and the second finger rest 144 and is configured to receive a portion of a user's interior finger's when the user's fingers are placed within the finger loop 126, such as, but not limited to a user's middle finger and ring finger.

Another ergonomic feature of the finger loop 126 is the surface of the inner ring 136 of the finger loop 126 located adjacent to the bottom surface 165 of the finger loop 126 which has a first generally straight surface 168 and a second generally straight surface 170 that meet at a lowermost generally curved surface 169, such that an angle α 1 is formed between the first generally straight surface 168 and the second generally straight surface 170.

In one configuration, the angle α 1 is greater than 90° and less than 180°. According to another configuration, the angle α 1 formed between the first generally straight surface 168 and the second generally straight surface 170 is between 150° and 170°.

As will be appreciated, by providing the angle α 1 via the lowermost generally curved surface 169 between the first generally straight surface 168 and the second generally straight surface 170 it provides sufficient clearance through the opening 138 of the finger loop 126 for a user to place all of their pointer finger, middle finger, ring finger, and pinky finger, when desired.

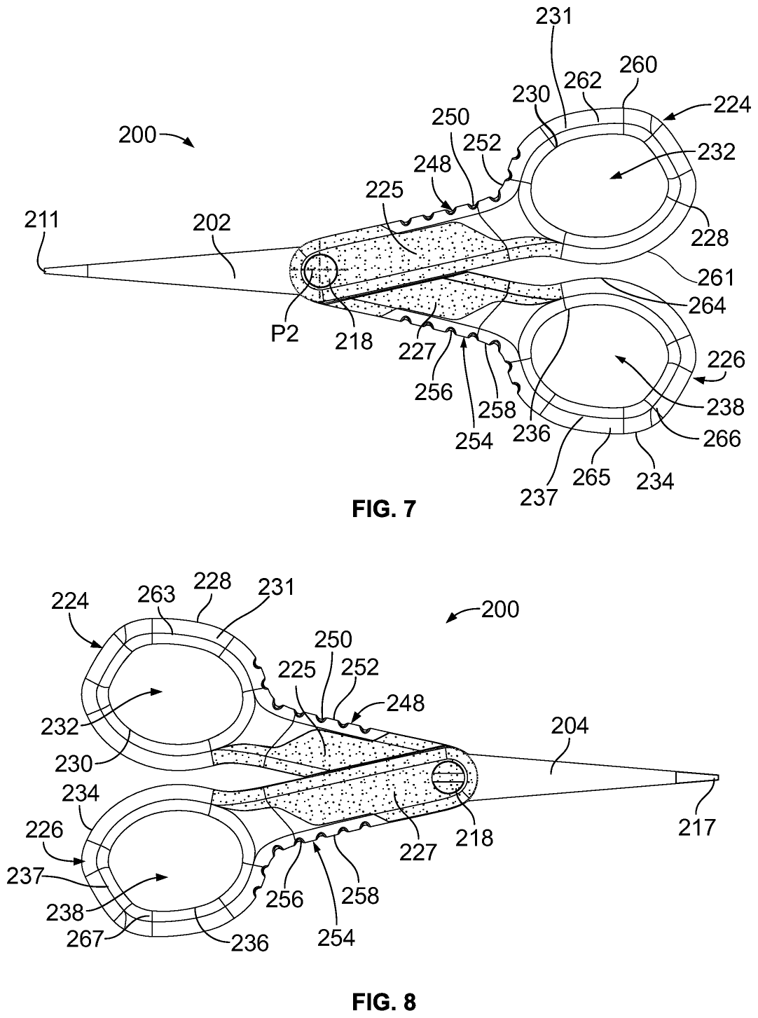

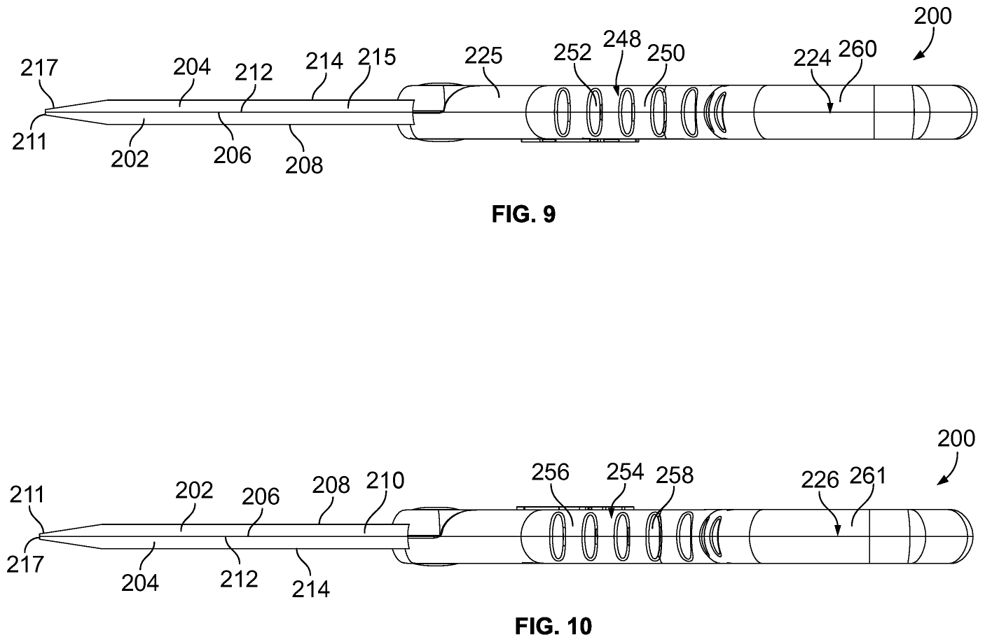

FIGS. 7-12 illustrate another embodiment of a pair of scissors 200 according to one aspect of the present application. The scissors including a first blade 202 and a second blade 204. The first blade 202 including a cutting edge 206, a blade wall 208, a backside 210 and a tip 211. The second blade 204 including a cutting edge 212, a blade wall 214, a backside 215 and a tip 217. The first blade 202 and the second blade 204 are pivotally coupled together at pivot point P2 via a coupling mechanism 218, such as, but not limited to a tension knob, tension dial, or a screw.

In one approach, the first blade 202 and the second blade 204 can be formed of a metal material. For example, the metal material can be a Steel, a Stainless Steel, a Carbon Steel, a Zinc Alloy, a Gray Iron, a White Iron, a Ductile Iron, a Copper-Based Alloy, a Nickel-Based Alloy, an Aluminum Alloy, a Magnesium, a Zinc, a Tin and/or a Lead.

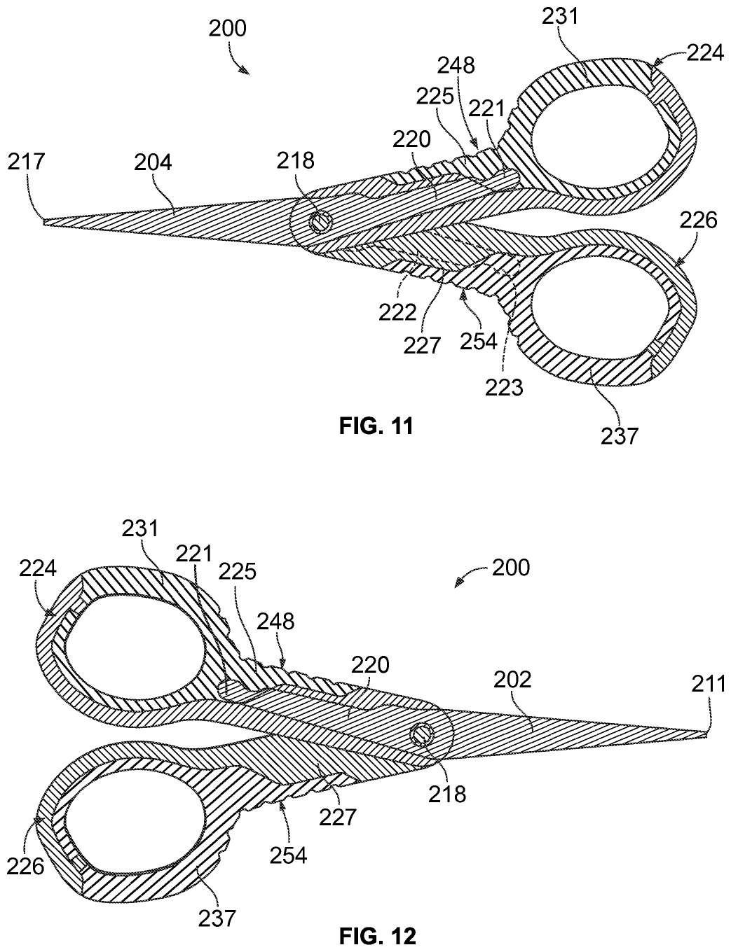

As shown in FIGS. 11 and 12, the first blade 202 has a first shank 220 and the second blade 204 has a second shank 222. The first shank 220 including a rounded or bulbous end 221 configured to facilitate a first grasping loop 224 being securely coupled with the first blade 202 and the second shank 222 including a rounded or bulbous end 223 to facilitate a second grasping loop 226 being securely coupled with the second blade 204.

In one approach, the first grasping loop 224 is securely coupled to the first blade 202 by overmolding the first grasping loop 224onto the first shank 220 and having the overmolded material extend around the first rounded or bulbous end221 of the first shank 220. Likewise, the second grasping loop 226 is securely coupled to the second blade 204 by overmolding the second grasping loop 226 onto the second shank 222 and having the overmolding material extend around the second rounded or bulbous end223 of the second shank 222.

The overmolding of the first grasping loop 224 on the first rounded or bulbous end 221 of the first shank 220 will create a first neck portion 225 that extends between the first grasping loop 224 and the first blade 202, such that the first grasping loop 224 is securely coupled with the first blade 202. Likewise, the overmolding of the second grasping loop 226 on the second rounded or bulbous end 223 of the second shank 222 will create a second neck portion 227 that extends between the second grasping loop 226 and the second blade 204, such that the second grasping loop 226 is securely coupled with the second blade 204.

In one approach, the overmolding used to form the first grasping loop 224 and the second grasping loop 226 can be a plastic material. For example, the plastic material used to overmold the first grasping loop 224 and the second grasping loop 226 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

Returning to FIGS. 7 and 8. the first grasping loop 224 further includes a top 260, a bottom 261, a first side 262, and a second side 263 that is opposite the first side 262. Likewise, the second grasping loop 226 includes a top 264, a bottom 265, a first side 266, and a second side 267 that is opposite the first side 266.

The first grasping loop 224 further including an outer ring 228 and an inner ring 230 with the inner ring 230 defining an opening 232 having a generally circular shape through the first grasping loop 224 that is configured to receive the thumb or other finger of a user. The second grasping loop 226 also including an outer ring 234 and an inner ring 236 with the inner ring 236 defining an opening 238 having a generally circular shape through the second grasping loop 226 that is configured to receive one or more fingers of a user.

The inner ring 230 and outer ring 228 of the first grasping loop 224 including a first grip or gripping element 231 that extends about the inner ring 230 and the outer ring 228 of the first grasping loop 224. The inner ring 236 and the outer ring 234 of the second grasping loop 226 including a second grip or gripping element 237 that extends about the inner ring 236 and the outer ring 234 of the second grasping loop 226. The first gripping element 231 and the second gripping element 237 are formed of a gripping material that provides a grip or increased traction to a user's thumb and one or more fingers as they engage with the respective inner rings 230, 236 and/or outer rings 228, 234 of the respective the first grasping loop 224 and second grasping loop 226.

The first grasping loop 224 also includes a third grip or gripping element 248 that at least partially extends along the first neck portion 225 and outer ring 228 of the first grasping loop 224. By one approach the third gripping element 248 includes a plurality of ridges or fins 252 interspersed between a plurality of notches, depressions, or gullies 250. The third gripping element 248 provides a gripping element for a user to place the terminal end of their thumb or other finger when it has been placed through the first grasping loop 224 to provide a surface for the terminal end of the thumb or other finger to help guide and provide a downward and lateral force on the first grasping loop 224 when the scissors are being used to cut a piece of material.

In some embodiments the second grasping loop 226 also includes a fourth grip or gripping element 254 that at least partially extends along the second neck portion 227 and outer ring 234 of the second grasping loop 226. The fourth gripping element 254 also includes a plurality of ridges or fins 258 interspersed between a plurality of notches, depressions, or gullies 256. The fourth gripping element 254 provides a gripping surface for a user to place one or more of their fingers that has not been placed through the first grasping loop 224 and provides a surface for one or more of these fingers to help guide and provide an upward force on the second grasping loop 226 when the scissors 200 are being used to cut a piece of material.

By having scissors with both the third gripping element 248 and the fourth gripping element 254 disposed on opposite sides thereof, a user may flexibly utilize the scissors with either the third or fourth gripping elements 248, 254 disposed adjacent portions of the fingers.

In one approach, the first gripping element 231, the second gripping element 237, the third gripping element 248, and the fourth gripping element 254 can be comprised of a second plastic material that is overmolded directly on the first plastic material that that makes the first grasping loop 224 and the second grasping loop 226 as discussed above. According to another approach, the second plastic material that forms the first gripping element 231, the second gripping element 237, the third gripping element 248, and the fourth gripping element 254 can be a Thermoplastic Elastomer (TPE) or a Thermoplastic Rubber (TPR).

In one approach, the third gripping element 248 can be formed during the same overmolding process that forms the first gripping element 231 that extends about the inner ring 230 and the outer ring 228 of the first grasping loop 224, such that the third gripping element 248 and the first gripping element 231 are formed from the same continuous or unitary piece of gripping material.

In another approach, the third gripping element 248 can be formed from a separate or non-continuous piece of gripping material than the piece of gripping material that makes up the first gripping element 231 that extends about the inner ring 230 and the outer ring 228 of the first grasping loop 224.

In one approach, the fourth gripping element 254 can be formed during the same overmolding process that forms the second gripping element 237 that extends about the inner ring 235 and the outer ring 234 of the second grasping loop 226, such that the fourth gripping element 254 and the second gripping element 237 are formed from the same continuous piece of gripping material.

In another approach, the fourth gripping element 254 can be formed from a separate or non-continuous piece of gripping material than the piece of gripping material that makes up the second gripping element 237 that extends about the inner ring 235 and the outer ring 234 of the second grasping loop 226, such that the fourth gripping element 254 and the second gripping element 237 are formed from separate or non-continuous pieces of gripping material.

In one approach, the first gripping element 231, the second gripping element 237, the third gripping element 248, and the fourth gripping element 254 can be comprised of a polymer material such as a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

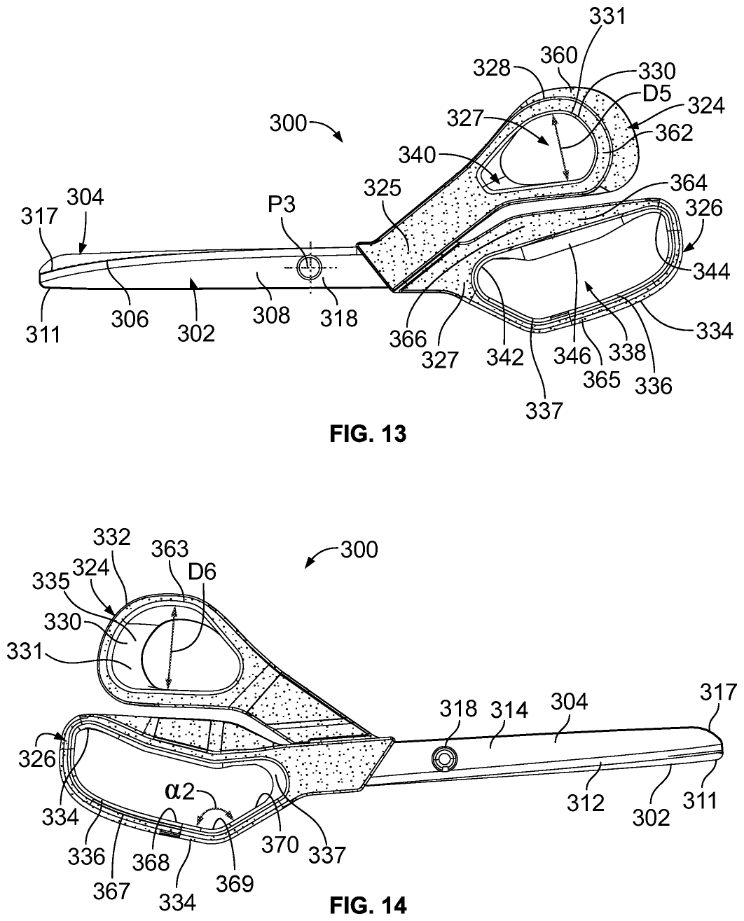

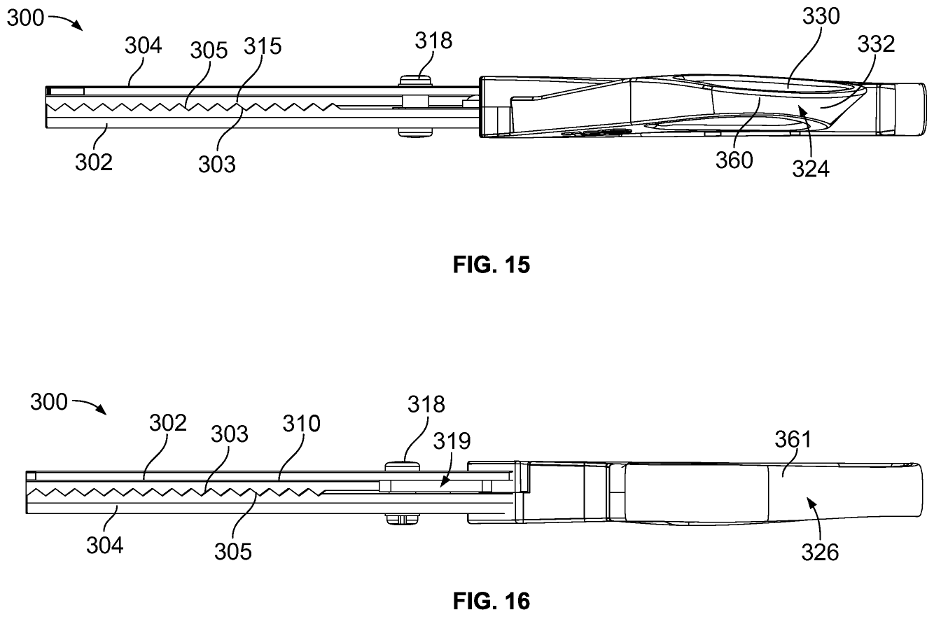

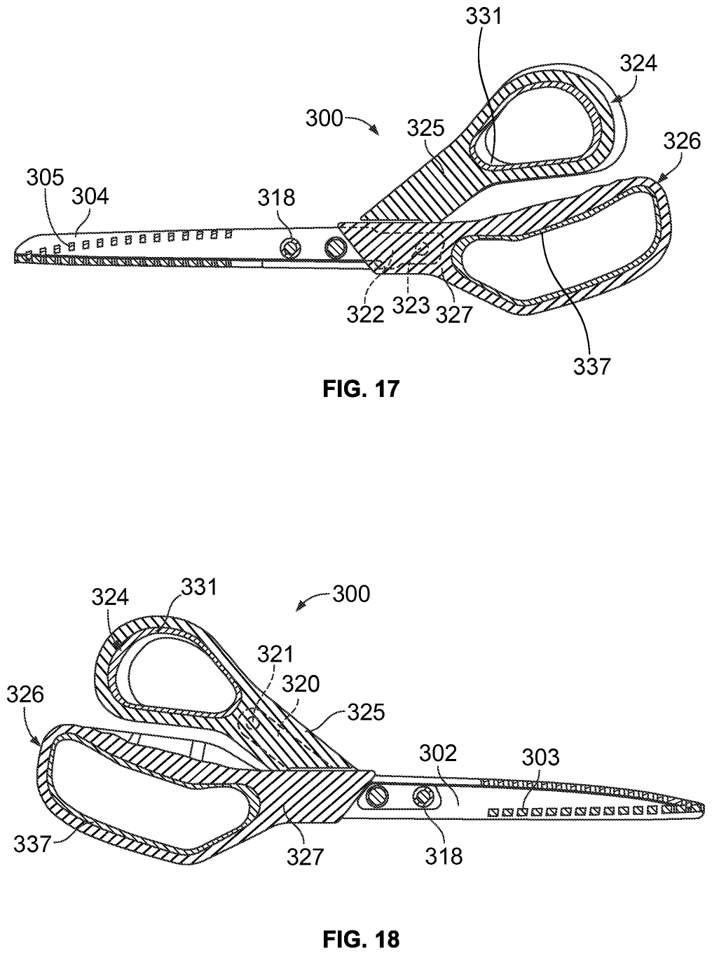

FIGS. 13-18 illustrate another embodiment of a pair of scissors 300 according to one aspect of the present application. The scissors including a first blade 302 and a second blade 304. The first blade 302 including a cutting edge 306, a blade wall 308, a backside 310 and a tip 311. The second blade 304 including a cutting edge 312, a blade wall 314, a backside 315 and a tip 317. The first blade 302 and the second blade 304 are pivotally coupled together at pivot point P3 via a coupling mechanism 318, such as, but not limited to a tension knob, tension dial, or a screw.

In one configuration the cutting edges 306, 312 of the first and second blade 302, 304, respectively, have a serrated edges with first and a second plurality of teeth 303, 305. In operation the first plurality of teeth 303 and the second plurality of teeth 305 are configured to engage with one another when the cutting edge 306 of the first blade 302 and the cutting edge 312 of the second blade 304 are at least partially aligned with one another, such as when the cutting edge 306 of the first blade 302 and the cutting edge 312 of the second blade 304 are brought together when cutting a piece of material. The scissors 300 will form cuts in pieces of material having a zigzag shape due to the respective first and second plurality of teeth 303, 305 provided on the respective first and second blade 302, 304. In short, the serrated configuration of the first and second blades 302, 304 creates a serrated configuration or zigzag shape to the material being cut.

In one approach, the first blade 302 and the second blade 304 can be formed of a metal material. For example, the metal material can be a Steel, a Stainless Steel, a Carbon Steel, a Zinc Alloy, a Gray Iron, a White Iron, a Ductile Iron, a Copper-Based Alloy, a Nickel-Based Alloy, an Aluminum Alloy, a Magnesium, a Zinc, a Tin and/or a Lead.

Like previously described embodiments the first blade 302 has a first shank 320 and the second blade 304 has a second shank 322. The first shank 320 including a first opening or coupling notch 321 configured to facilitate a thumb loop 324 being securely coupled with the first blade 302 and the second shank 322 including a second opening or notch 323 that to facilitate a finger loop 326 being securely coupled with the second blade 304.

In one approach, the thumb loop 324 is securely coupled to the first blade 302 by overmolding the thumb loop 324 onto the first shank 320 and having the overmolded material extend into, around, and/or through the first coupling notch 321. Likewise, the finger loop 326 is coupled to the second blade 304 by overmolding the finger loop 326 onto the second shank 322 and having the overmolding material extend into, around, and/or through the second coupling notch 323.

The overmolding of the thumb loop 324 on the first coupling notch 321 will create a first neck portion 325 that extends between the thumb loop 324 and the first blade 302, such that the thumb loop 324 is securely coupled with the first blade 302. Likewise, the overmolding of the finger loop 326 on the second coupling notch 323 will create a second neck portion 327 that extends between the finger loop 326 and the second blade 304, such that the finger loop 326 is securely coupled with the second blade 304.

In one approach, the overmolding used to form the thumb loop 324 and the finger loop 326 can be a plastic material. For example, the plastic material used to overmold the thumb loop 324 and the finger loop 326 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

The thumb loop 324 further includes a top 360, a bottom 361, a first side 362, and a second side 363 that is opposite the first side 362. Likewise, the finger loop 326 includes a top 364, a bottom 365, a first side 366, and a second side 367 that is opposite the first side 366.

The thumb loop 324 further including an outer ring 328 and an inner ring 330 with the inner ring 330 defining an opening 332 through the finger loop 326 that is configured to receive the thumb of a user. The finger loop 326 also including an outer ring 334 and an inner ring 336 with the inner ring 336 defining an opening 338 through the finger loop 326 that is configured to receive one or more fingers of a user.

By some approaches, the inner ring 330 of the thumb loop 324 includes a first gripping element 331 and the inner ring 336 of the finger loop 326 including a second gripping element 337. The first gripping element 331 and the second gripping element 337 are typically comprised of a gripping material that provides grip to a user's thumb and one or more fingers as they engage with the respective inner rings 330, 336 of the thumb loop 324 and finger loop 326.

In one approach, the gripping material of the first gripping element 331 and the second gripping element 337 are formed of a second plastic material that is overmolded directly on the first plastic material that that makes the thumb loop 324 and the finger loop 326 as discussed above. According to another approach, the second plastic that makes up the gripping material may be a Thermoplastic Elastomer (TPE) or a Thermoplastic Rubber (TPR).

In another approach the gripping material of the first gripping element 331 and the second gripping element 337 may be made from a polymer material such as a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

In some embodiments the opening 332 defined by the inner ring 330 of the thumb loop 324 has a generally oblong shape. The inner ring 330 of the thumb loop 324 also being tapered and/or angled between its first side 362 and second side 363. By one approach, the opening 332 through the thumb loop 324 has diameter D5 that is smaller on the first side 362 of the thumb loop 324 than a diameter D6 of the opening 332 on the second side 363 of the thumb loop 324. In some embodiments, the walls for the opening forming the inner ring 330 are angled toward the tip 311.

Due to the diameter D5 being smaller than the diameter D6, the inner ring 330 has a natural incline or slope as it extends between the second side 363 to the first side 362 of the thumb loop 324. As will be discussed further below, the natural incline or slope of the inner ring 330 provides users with ergonomic benefits over thumb loops on currently available scissors and shears. For example, a user's thumb will have a greater range of motion when it is inserted through the thumb loop 324 when compared to currently available thumb loops. This, in turn, provides the user not only additional comfort, but also the ability to apply more downward force on the thumb loop 324 compared to available scissors and shears. For example, the greater range of motion allows a user to rotate their thumb within the thumb loop 324 so that the middle portion of their thumb can apply greater downward force on the first side 362 of the thumb loop 324 than would be possible with the thumb loops on available scissors and shears. Likewise, the greater range of motion also allows the user to rotate their thumb within the thumb loop 324 so that the base portion of their thumb can apply greater downward force on the second side 363 of the thumb loop 324 than would be possible with the scissors and shears currently available on the market.

As will be appreciated, angling and/or tapering the inner ring 330 of the thumb loop 324 (e.g., disposing the opening 332 such that the first side 362 of the thumb loop 324 is smaller than the diameter of the second side 363 of the thumb loop 324 and/or angling the walls of the opening such that the second side of the opening is disposed rearward of the first side), provides a first thumb rest 335 on the inner ring 330 of the thumb loop 324. The first thumb rest 335 provides the user's thumb with the ergonomic benefit of a greater range of motion when the user's thumb is inserted into the thumb loop 324. In addition to the obvious comfort benefits that comes with a greater range of motion, the first thumb rest 335 also allows the user to cut through thicker materials with greater ease than would be possible using traditional scissors. The thumb rest 335 does this by providing greater clearance for the base of a user's thumb to rotate inwardly toward the second side 363 of the thumb loop 324, which in turn, allows the base of the user's thumb to apply greater downward force on the second side 363 of the thumb loop 324 than would be possible with the thumb loops found on currently available scissors and shears.

The angling and tapering of the inner ring 330 of the thumb loop 324 also provides a second thumb rest 340 on the thumb loop 324 that provides additional clearance for a middle portion of a user's thumb to rotate inwardly toward the first side 362 of the thumb loop 324 when the user is applying a downward force on the thumb loop 324 to bring the first blade 302 and the second blade 304 together, such as when the user is bringing the first blade 302 and the second blade 304 together to cut a piece of material.

As with the first thumb rest 335 discussed above, the additional clearance provided by the second thumb rest 340 allows for greater rotation of the middle portion of a user's thumb toward the first side 362 of the thumb loop 324 than would be possible with the thumb loops of the scissors and shears available on the market today. This, in turn, allows the middle portion of the user's thumb to apply greater downward force on the first side 362 of the thumb loop 324 than would be possible with the thumb loops found on traditional scissors and shears. Thus, the second thumb rest 340 not only provides the user with the obvious ergonomic benefits that come with having a greater range of motion, but it also allows a user to cut through thicker pieces of materials with greater ease than would be possible with the thumb loops on current scissors and shears.

A further ergonomic feature of the scissors 300 is the shape of the opening 338 of the finger loop 326 that is defined by a wall or surface of the inner ring 336 of the finger loop 326. In one illustrative configuration, the inner ring 336 of the finger loop 326 located adjacent to the top 364 of the finger loop 326 having a first finger rest 342 having a generally curved shape and a second finger rest 344 having generally curved shape. In addition, the inner ring 336 also may have a third finger rest 346. In some embodiments, the third finger rest 346 has a portion thereof that is a generally linear or flat shaped extending between the first and second finger rests.

As will be appreciated, the first finger rest 342 with a generally curved shape is configured to receive a user's frontmost finger that is placed within the finger loop 326, such as, but not limited to a user's pointer finger or middle finger and the second finger rest 344 with a generally curved shape is configured to receive a user's rearmost finger that is placed within the finger loop 326, such as, but not limited to a user's pinky finger or ring finger.

As will be further appreciated, the first finger rest 342 provides the ergonomic benefit of stabilizing a user's frontmost finger when the user is grasping the finger loop 326 and applying an upward force on the finger loop 326 when bringing the finger loop 326 and the thumb loop 324 together, such as when cutting a piece of material. Likewise, the second finger rest 344 also provides the ergonomic benefit of stabilizing a user's rearmost finger when the user is grasping the finger loop 326 and applying an upward force on the finger loop 326 when bringing the finger loop 326 and the thumb loop 324 together, such as when cutting a piece of material.

In addition, the first finger rest 342 and the second finger rest 344 provide additional clearance within the finger loop 326, such that a user may grasp the finger loop 326 with one or more additional fingers compared to a finger loop on a traditional pair of scissors. As will be appreciated, being able to grasp the finger loop 326 with one or more additional fingers gives the user more stability or control over the scissors 300 and allows the user to apply additional upward finger force on the finger loop 326 when brining the finger loop 326 and the thumb loop 324 together, such as when a user is cutting a piece of material with the scissors 300.

Further, the third finger rest 346 disposed between the first and second finger rests is generally elongated and linear or flat shaped. By one approach, the third finger rest 346 extends between the first finger rest 342 and the second finger rest 344 and is configured to receive a user's interior fingers when the user's fingers are placed within the finger loop 326, such as, but not limited to a user's middle finger and ring finger.

Another ergonomic feature of the finger loop 326 is the surface of the inner ring 336 of the finger loop 326 located adjacent to the bottom surface 365 of the finger loop 326 which has a first generally straight surface 368 and a second generally straight surface 370 that meet at a lowermost generally curved surface 369, such that an angle α 2 is formed between the first generally straight surface 368 and the second generally straight surface 370.

In one configuration, the angle α 2 is greater than 90° and less than 180°. According to another configuration, the angle α 2 formed between the first generally straight surface 368 and the second generally straight surface 370 is between 150° and 170°.

As will be appreciated, by providing the angle α 3 via the lowermost generally curved surface 369 between the first generally straight surface 368 and the second generally straight surface 370 it provides sufficient clearance through the opening 338 of the finger loop 326 for a user to place all of their pointer finger, middle finger, ring finger, and pinky finger, when desired.

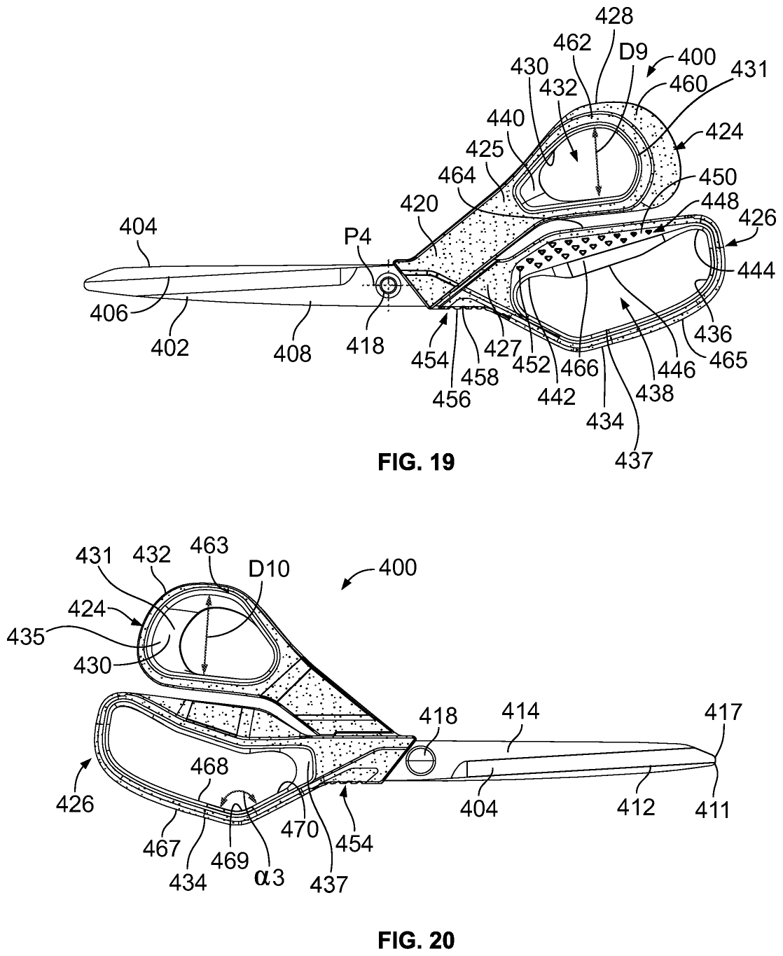

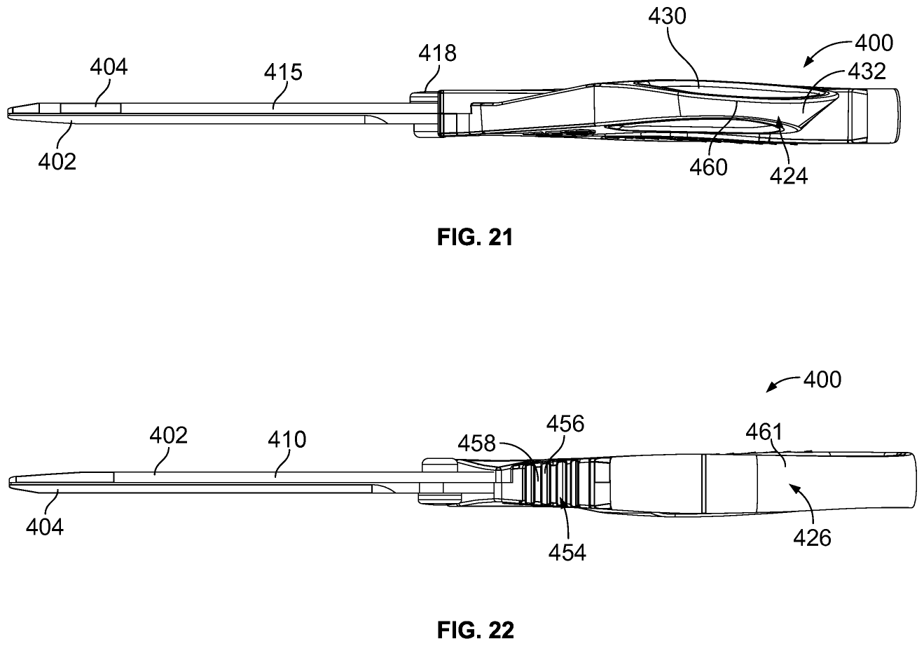

FIGS. 19-24 illustrate one embodiment of a pair of scissors 400 according to one aspect of the present application. The scissors 400 include a first blade 402 and a second blade 404. The first blade 402 includes a cutting edge 406, a blade wall 408, a backside 410 and a tip 411. The second blade 404 includes a cutting edge 412, a blade wall 414, a backside 415 and a tip 417. The first blade 402 and the second blade 404 are pivotally coupled together at pivot point P4 via a coupling mechanism 418, such as, but not limited to a tension knob, tension dial, or a screw.

In one approach, the first blade 402 and the second blade 404 are formed of a metal material. For example, the metal material can be a Steel, a Stainless Steel, a Carbon Steel, a Zinc Alloy, a Gray Iron, a White Iron, a Ductile Iron, a Copper-Based Alloy, a Nickel-Based Alloy, an Aluminum Alloy, a Magnesium, a Zinc, a Tin and/or a Lead.

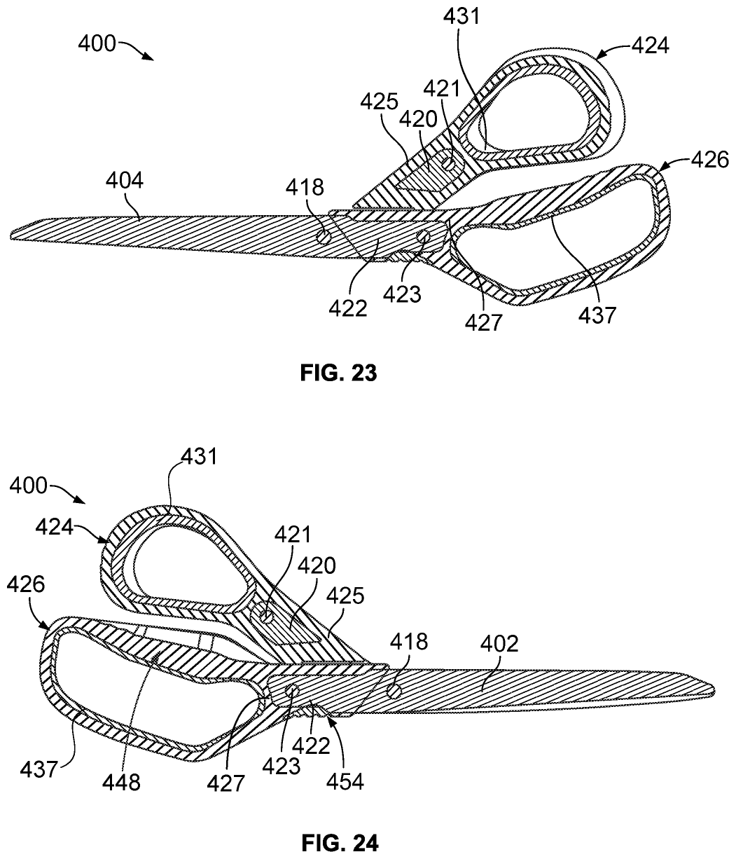

The first blade 402 has a first shank 420 and the second blade 404 has a second shank 422. As shown in FIGS. 23 and 24, the first shank 420 includes a first coupling notch 421 configured to facilitate a thumb loop 424 being securely coupled with the first blade 402, and the second shank 422 including a second coupling notch 423 configured to facilitate a finger loop 426 being securely coupled with the second blade 404.

In one approach, the thumb loop 424 is coupled to the first blade 402 by overmolding the thumb loop 424 onto the first shank 420 and having the overmolding material extend in, around, and or through the first coupling notch 421. Likewise, the finger loop 426 is securely coupled to the second blade 404 by overmolding the finger loop 426 on the second shank 422 and having overmolded material extend in, around, and/or through the opening or the second coupling notch 423.

The overmolding of the finger loop 426 on the second coupling notch 421 will create a second neck portion 427 that extends between the finger loop 426 and the second blade 404, such that the finger loop 426 is securely coupled with the second blade 404. Likewise, the overmolding of the thumb loop 424 on the first coupling notch 421 will create a first neck portion 425 that extends between the thumb loop 424 and the first blade 402, such that the thumb loop 424 is securely coupled with the first blade 402.

In one approach, the overmolding used to form the thumb loop 424 and the finger loop 426 can be a plastic material. For example, the plastic material used to overmold the thumb loop 424 and the finger loop 426 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

Returning to FIGS. 19 and 20, the thumb loop 424 further includes a top 460, a bottom 461, a first side 462, and a second side 463 that is opposite the first side 462. Likewise, the finger loop 426 includes a top 464, a bottom 465, a first side 466, and a second side 467 that is opposite the first side 466.

The thumb loop 424 further including an outer ring 428 and an inner ring 430 with the inner ring 430 defining an opening 432 through the thumb loop 324 that is configured to receive the thumb of a user. The finger loop 426 also including an outer ring 434 and an inner ring 436 with the inner ring 436 defining an opening 438 through the finger loop 426 that is configured to receive one or more fingers of a user.

In one illustrative embodiment, the inner ring 430 of the thumb loop 424 including a first gripping element 431 that extends about or over at least portions of the inner ring 430 of the thumb loop 424. In some configurations, the inner ring 436 of the finger loop 426 includes a second gripping element 437 that extends about or over at least portions of the inner ring 436 of the finger loop 426. By some approaches, the first gripping element 431 and the second gripping element 437 are comprised of a gripping material that provides grip to a user's thumb and one or more fingers as they engage with the respective inner rings 430, 436 of the thumb loop 424 and finger loop 426.

In one configuration, the gripping material of the first gripping element 431 and the second gripping element 437 are comprised of a second plastic material that is overmolded directly on the first plastic material that that makes the thumb loop 424 and the finger loop 426 as discussed above. According to another configuration, the second plastic that makes up the gripping material of the first gripping element 431 and the second gripping element 437 may be a Thermoplastic Elastomer (TPE) or a Thermoplastic Rubber (TPR).

The opening 432 defined by the inner ring 430 of the thumb loop 424 may have a generally oblong shape. The inner ring 430 of the thumb loop 424 also may be tapered and/or angled between its first side 462 and second side 463. By one approach, the opening 432 through the thumb loop 424 has diameter D9 that is smaller on the first side 462 of the thumb loop 424 than a diameter D10 of the opening 432 on the second side 463 of the thumb loop 424. In some embodiments, the walls of the opening forming the inner ring 430 are angled toward the tip 411 of the first blade 402.

Due to the diameter D9 being smaller than the diameter D10, the inner ring 430 has a natural incline or slope as it extends between the second side 463 to the first side 462 of the thumb loop 424. As will be discussed further below, the natural incline or slope of the inner ring 430 provides users with ergonomic benefits over thumb loops found on traditional scissors and shears. For example, a user's thumb will have a greater range of motion when it is inserted through the thumb loop 424 when compared to current thumb loops. This, in turn, provides the user not only additional comfort, but also the ability to apply more downward force on the thumb loop 424 compared to the scissors and shears available on the market today. For example, the greater range of motion allows a user to rotate their thumb within the thumb loop 424 so that the middle portion of their thumb can apply greater downward force on the first side 462 of the thumb loop 424 than would be possible with the thumb loops that are currently available. Likewise, the greater range of motion also allows the user to rotate their thumb within the thumb loop 424 so that the base portion of their thumb can apply greater downward force on the second side 463 of the thumb loop 424 than would be possible with the thumb loops on currently available scissors and shears.

As will be appreciated, tapering and/or angling the inner ring 430 of the thumb loop 424 (e.g., disposing the opening 432 such that the first side 462 of the thumb loop 424 is smaller than the diameter of the second side 463 of the thumb loop 424 and/or angling the walls of the opening such that the second side 463 of the opening is disposed rearward of the first side 462) provides a first thumb rest 435 on the inner ring 430 of the thumb loop 424. The first thumb rest 435 provides the user's thumb with the ergonomic benefit of a greater range of motion when the user's thumb is inserted into the thumb loop 424. In addition to the obvious comfort benefits that comes with a greater range of motion, the first thumb rest 435 also allows the user to cut through thicker materials with greater ease than would be possible using traditional scissors and shears. The thumb rest 435 does this by providing greater clearance for the base of a user's thumb to rotate inwardly toward the second side 463 of the thumb loop 424, which in turn, allows the base of the user's thumb to apply greater downward force on the second side 463 of the thumb loop 424 than would be possible with the currently available thumb loops.

The angling and/or tapering of the inner ring 430 of the thumb loop 424 also provides a second thumb rest 440 on the thumb loop 424 that provides clearance for the middle portion of a user's thumb to rotate inwardly toward the first side 462 of the thumb loop 424 when the user is applying a downward force on the thumb loop 424 to bring the first blade 402 and the second blade 404 together, such as when the user is bringing the first blade 402 and the second blade 404 together to cut a piece of material.

As with the first thumb rest 435 discussed above, the clearance provided by the second thumb rest 440 allows for greater rotation of the middle portion of a user's thumb toward the first side 462 of the thumb loop 424 than would be possible with the thumb loops on available scissors and shears. This, in turn, allows the middle portion of the user's thumb to apply greater downward force on the first side 462 of the thumb loop 424 than would be possible with currently known thumb loops. Thus, the second thumb rest 440 not only provides the user with the obvious ergonomic benefits that come with having a greater range of motion, but it also allows a user to cut through thicker pieces of materials with greater ease than would be possible with the thumb loops found on currently available scissors and shears.

In some embodiments, the finger loop 426 also includes a third grip or gripping element 448 that extends at least partially along the first side of the 466 of the finger loop 426. As shown, the third gripping element 448 includes a textured surface or patter facilitating an increase of friction between the finger loop 426 and a user's fingers when the user is grasping the finger loop 426.

In one approach, the third gripping element 448 has a surface 450, which may be generally smooth, that has a plurality of discrete protrusions 452 disposed thereon, like those described above. The plurality of discrete protrusions 452 may be, but are not required to be, uniformly spaced out along the surface 450 of the third gripping element 448. The plurality of discrete protrusions 452 may be any shape generally known in the art, such as, but not limited to being triangular in shape.

In one approach, the gripping material of the third gripping element 448 is comprised of a second plastic material that is overmolded directly on the first plastic material that makes the finger loop 426 as discussed above. According to another approach, the second plastic that makes up the gripping material of the third gripping element 448 may be a Thermoplastic Elastomer (TPE) or a Thermoplastic Rubber (TPR).

In another approach, the third gripping element 448 can be formed during the same overmolding process that forms the second gripping element 437 that extends about the inner ring 436 of the finger loop 426, such that the third gripping element 448 and the second gripping element 437 are formed from the same continuous piece of gripping material.

In another approach, the third gripping element 448 can be formed separate from the second gripping element 437 that extends about the inner ring 436 of the finger loop 426, such that the third gripping element 448 is formed from a separate or non-continuous piece of gripping material than the piece of gripping material that forms the second gripping element 437.

In some embodiments, the finger loop 426 also includes a fourth grip or gripping element 454 that is located on the bottom side 465 of the finger loop 426 and more specifically on the second neck portion 427 formed between the second blade 404 and the finger loop 426. By some approaches, the fourth gripping element 454 includes a plurality of ridges or fins 456 interspersed between a plurality of notches, depressions, or gullies 458. As disposed, the fourth gripping element 454 provides a gripping surface for a user to place their pointer finger when grasping the finger loop 426 with one or more of their middle finger, ring finger, or pinky finger, like those described above.

According to one approach, when a user places their pointer finger on the fourth gripping element 454 while using the scissors 400 it provides a means for the user to stabilize the direction that the respective blades 402, 404 of the scissors are pointing when cutting a material as well as providing an additional means to apply an upward force on the second blade 404 of the scissors 400 when bringing the first blade 402 and the second blade 404 together to cut a piece of material.

In one approach, the fourth gripping element 454 can be formed from a plastic material. For example, the plastic material forming the fourth gripping element 454 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

In another approach, the fourth gripping element 454 can be formed during the same overmolding process that forms the finger loop 426, such that the fourth gripping element 454 and the finger loop 426 are formed from the same continuous piece of plastic material.

In another approach, the fourth gripping element 454 can be formed separate from the finger loop 426, such that the fourth gripping element 454 is formed from a separate or non-continuous piece of plastic material than the piece of plastic material that forms the finger loop 426.

In still yet another approach, the fourth gripping element 454 can be comprised of a second plastic material that is overmolded directly on the first plastic material that makes the finger loop 426 as discussed above. In yet another approach, the second plastic that makes up the fourth gripping element 454 can be a Thermoplastic Elastomer (TPE) or a Thermoplastic Rubber (TPR).

In another approach the gripping material of the first gripping element 431, the second gripping element 437, the third gripping element 448 and the fourth gripping element 454 may be made from a polymer material such as a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

A further ergonomic feature of the scissors 400 is the shape of the opening 438 of the finger loop 426 that is defined by a wall or surface of the inner ring 436 of the finger loop 426. in one illustrative configuration, the inner ring 436 of the finger loop 426 located adjacent to the top 464 of the finger loop 426 has a first finger rest 442 having a generally curved shape and a second finger rest 444 having generally curved shape with a third finger rest 446 having a generally elongated and flat or linear shaped extending therebetween.

In one approach, the first finger rest 442 with a generally curved shape is configured to receive a user's frontmost finger that is placed within the finger loop 426, such as, but not limited to a user's pointer finger or middle finger and the second finger rest 444 with a generally curved shape is configured to receive a user's rearmost finger that is placed within the finger loop 426, such as, but not limited to a user's pinky finger or ring finger.

As will be appreciated, the first finger rest 442 provides the ergonomic benefit of stabilizing a user's frontmost finger when the user is grasping the finger loop 426 and applying an upward force on the finger loop 426 when bringing the finger loop 426 and the thumb loop 424 together, such as when cutting a piece of material. Likewise, the second finger rest 444 also provides the ergonomic benefit of stabilizing a user's rearmost finger when the user is grasping the finger loop 426 and applying an upward force on the finger loop 126 when bringing the finger loop 426 and the thumb loop 424 together, such as when cutting a piece of material.

In addition, the first finger rest 442 and the second finger rest 444 provide additional clearance within the finger loop 426, such that a user may grasp the finger loop 426 with one or more additional fingers compared to a finger loop on a traditional pair of scissors. As will be appreciated, being able to grasp the finger loop 426 with one or more additional fingers gives the user more stability or control over the scissors 400 and allows the user to apply additional upward finger force on the finger loop 426 when brining the finger loop 426 and the thumb loop 424 together, such as when a user is cutting a piece of material with the scissors 400.

Further, the third finger rest 446 disposed between the first and second finger rests is generally elongated and linear or flat shaped. By one approach, the third finger rest 446 extends between the first finger rest 442 and the second finger rest 444 and is configured to receive a portion of a user's interior fingers when the user's fingers are placed within the finger loop 426, such as, but not limited to a user's middle finger and ring finger.

Another ergonomic feature of the finger loop 426 is the surface of the inner ring 436 of the finger loop 426 located adjacent to the bottom surface 465 of the finger loop 426 which has a first generally straight surface 468 and a second generally straight surface 470 that meet at a lowermost generally curved surface 469, such that an angle α 3 is formed between the first generally straight surface 468 and the second generally straight surface 470.

In one configuration, the angle α 4 is greater than 90° and less than 180°. According to another configuration, the angle α 3 formed between the first generally straight surface 468 and the second generally straight surface 470 is between 150° and 170°.

As will be appreciated, by providing the angle α 3 via the lowermost generally curved surface 469 between the first generally straight surface 468 and the second generally straight surface 470 it provides sufficient clearance through the opening 438 of the finger loop 426 for a user to place all of their pointer finger, middle finger, ring finger, and pinky finger, when desired.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents used in the present application (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate what is being disclosed by the present application and does not pose a limitation on the scope of the disclosure in the present application unless otherwise claimed. No language in the specification should be construed as indicating any non-claimed element as essential to the practice of what is disclosed by the present application.

Preferred embodiments disclosed in the present application are described herein, including the best mode known by the applicants for carrying out what is disclosed in the present application. Variations of those preferred embodiments may become apparent to those of ordinary skill in the art upon reading the foregoing description. The applicants expect skilled artisans to employ such variations as appropriate, and the applicants intend for the disclosure in the present application to be practiced otherwise than as specifically described herein.

Accordingly, the disclosure of this application includes all modifications and equivalents of the subject matter recited in the claims appended hereto as permitted by applicable law. Moreover, any combination of the above-described elements in all possible variations thereof is encompassed by the disclosure of the present application unless otherwise indicated herein or otherwise clearly contradicted by context

What is claimed is:

1. A pair of scissors comprising:
a first blade and a second blade;
the first blade and the second blade pivotally connected by a coupler;
the first blade coupled to a thumb loop and the second blade coupled to a finger loop;
a first gripping element extending about an inner ring of the thumb loop;
a second gripping element extending about an inner ring of the finger loop;
a third gripping element extending at least partially along a first side of the finger loop and including a plurality of protrusions; and
a fourth gripping element extending at least partially along a neck formed between the second blade and the finger loop and including a plurality of fins interspersed between a plurality of gullies.

2. The scissors of claim 1, wherein the inner ring of the finger loop includes a first finger rest and a second finger rest.

3. The scissors of claim 2, wherein the inner ring of the finger loop includes a first generally straight surface and a second generally straight surface that meet at a lowermost generally curved surface, such that an angle formed between the first generally straight surface and the second generally straight surface is greater than 90° and less than 180°.

4. The scissors of claim 3, wherein the finger loop has a generally oblong shape and is configured to receive a portion of a user's hand.

5. The scissors of claim 3, wherein the angle formed between the first generally straight surface and the second generally straight surface is between 150° and 170°.

6. The scissors of claim 1, wherein the thumb loop has a first side and a second side opposite the first side; and
wherein the inner ring is tapered between the first side and the second side, such that an opening through the thumb loop is larger on the first side of the thumb loop than the opening is on the second side of the thumb loop and wherein the inner ring is angled.

7. The scissors of claim 1, wherein the inner ring of the thumb loop includes a thumb rest that is positioned proximate to a neck that extends between the first blade and the thumb loop.

8. The scissors of claim 1, wherein the first blade and the second blade are formed of a metal material.

9. The scissors of claim 8, wherein the metal material is at least one of a Steel, a Stainless Steel, a Carbon Steel, a Zinc Alloy, a Gray Iron, a White Iron, a Ductile Iron, a Copper-Based Alloy, a Nickel-Based Alloy, an Aluminum Alloy, a Magnesium, a Zinc, a Tin or a Lead.

10. The scissors of claim 1, wherein the inner ring of the thumb loop and the inner ring of the finger loop are formed from a first plastic material.

11. The scissors of claim 10, wherein the first plastic material is one of an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

12. The scissors of claim 10, wherein the first gripping element is at least partially overmolded on the first plastic material that forms the thumb loop and the second gripping element is at least partially overmolded on the first plastic material that forms the finger loop.

13. The scissors of claim 12, wherein the first gripping element and the second gripping element are formed from a polymer material.

14. The scissors of claim 13, wherein the polymer material is a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

15. The scissors of claim 12, wherein the first gripping element and the second gripping element are comprised of a second plastic material.

16. The scissors of claim 15, wherein the second plastic material is a Thermoplastic Elastomer (TPE) or a Thermoplastic Rubber (TPR).

17. The scissors of claim 1, wherein the plurality of protrusions have a triangular shape.

18. The scissors of claim 1, wherein the coupler is a tension knob, a dial, or a screw.

19. The scissors of claim 1, wherein the first blade has a cutting edge, and the second blade has a cutting edge.

20. The scissors of claim 19, wherein the cutting edge of the first blade includes a first plurality of teeth, and the cutting edge of the second blade includes a second plurality of teeth.

21. The scissors of claim 19, wherein the cutting edge of the first blade and the cutting edge of the second blade have a generally smooth surface.

22. The scissors of claim 1, wherein the finger loop has an outer ring and wherein the second gripping element extends at least partially along the outer ring of the finger loop.

23. A pair of scissors comprising:
a first blade and a second blade;
the first blade and the second blade pivotally connected by a coupler;
the first blade coupled to a thumb loop and the second blade coupled to a finger loop;
the thumb loop having a first side and a second side opposite the first side with an inner ring extending therebetween; and
wherein the inner ring of the thumb loop is tapered between the first side and the second side of the thumb loop, such that an opening through the thumb loop is larger on the first side of the thumb loop than on the second side of the thumb loop.

24. The scissors of claim 23, wherein the finger loop includes a first finger rest and a second finger rest having a generally curved surface that are configured to receive a finger of a hand.

25. The scissors of claim 23, wherein an inner ring of the finger loop includes a first generally straight surface and a second generally straight surface that meet at a lowermost generally curved surface located adjacent to a bottom of the finger loop; and
wherein an angle formed between the first generally straight surface and the second generally straight surface that is greater than 90° and less than 180°.

26. The scissors of claim 23, further including a first gripping element extending about the inner ring of the thumb loop, a second gripping element extending about an inner ring of the finger loop, and a third gripping element extending at least partially along a first side of the finger loop and including a plurality of protrusions.

27. The scissors of claim 26, wherein the plurality of protrusions have a triangular shape.

28. The scissors of claim 26, including a fourth gripping element extending at least partially along a neck formed between the second blade and the finger loop.

29. The scissors of claim 27, wherein the fourth gripping element includes a surface with a repeating pattern having a plurality of valleys and ridges.

30. The scissors of claim 23, wherein the first blade and the second blade are formed of a metal material.

31. The scissors of claim 30, wherein the metal material is at least one of a Steel, a Stainless Steel, a Carbon Steel, a Zinc Alloy, a Gray Iron, a White Iron, a Ductile Iron, a Copper-Based Alloy, a Nickel-Based Alloy, an Aluminum Alloy, a Magnesium, a Zinc, a Tin or a Lead.

32. The scissors of claim 23, wherein the inner ring of the thumb loop and an inner ring of the finger loop are formed from a first plastic material.

33. The scissors of claim 32, wherein the first plastic material is one of an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

34. The scissors of claim 32, wherein a first gripping element, a second gripping element, and a third gripping element are formed from a gripping material;
wherein the first gripping element is formed by overmolding the gripping material on the first plastic material forming the thumb ring; and
wherein the second gripping element and the third gripping element are formed by overmolding the gripping material on the first plastic material forming the finger ring.

35. The scissors of claim 34, wherein the first gripping element, the second gripping element, and the third gripping element are formed from a polymer material.

36. The scissors of claim 35, wherein the polymer material is Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

37. The scissors of claim 34, wherein the gripping material is a second plastic material.

38. The scissors of claim 37, wherein the second plastic material is a Thermoplastic Elastomer (TPE) or a Thermoplastic Rubber (TPR).

39. The scissors of claim 23, wherein the coupler is a tension knob, a dial, or a screw.

40. The scissors of claim 23, wherein the first blade has a cutting edge, and the second blade has a cutting edge.

41. The scissors of claim 40, wherein the cutting edge of the first blade includes a first plurality of teeth, and the cutting edge of the second blade includes a second plurality of teeth.

42. A pair of scissors comprising:
a first blade and a second blade;
the first blade and the second blade pivotally connected by a coupler;
the first blade coupled to a thumb loop and the second blade coupled to a finger loop;
the thumb loop including an outer ring and an inner ring;
the inner ring of the thumb loop being tapered between a first side of thumb loop and a second side of the thumb loop;
the finger loop having a generally oblong shape and including an outer ring and an inner ring;
the inner ring of the finger loop including a first finger rest having a generally curved surface and a second finger rest having a generally curved surface;
the first finger rest and the second finger rest located adjacent to a top side of the finger loop;
the inner ring of the finger loop further including a first generally straight surface and a second generally straight surface that meet at a lowermost generally curved surface; and
wherein the first generally straight surface and the second generally straight surface meet at the lowermost generally curved surface to form an angle that is greater than 90° and less than 180°;
the thumb loop further including a first gripping element extending about the inner ring of the thumb loop; and
the finger loop further including a second gripping element extending about the inner ring of the finger loop, a third gripping element extending at least partially along a first side of the finger loop that is generally perpendicular to the inner ring of the finger loop, and a fourth gripping element extending at least partially along a neck formed between the second blade and the finger loop;

43. The scissors of claim 42, wherein the third gripping element includes a plurality of protrusions.

44. The scissors of claim 43, wherein the plurality of protrusions have a triangular shape.

45. The scissors of claim 42, wherein the fourth gripping element including a plurality of fins interspersed between a plurality of gullies.

46. The scissors of claim 42, wherein the first blade and the second blade are formed of a metal material.

47. The scissors of claim 46, wherein the metal material is at least one of a Steel, a Stainless Steel, a Carbon Steel, a Zinc Alloy, a Gray Iron, a White Iron, a Ductile Iron, a Copper-Based Alloy, a Nickel-Based Alloy, an Aluminum Alloy, a Magnesium, a Zinc, a Tin or a Lead.

48. The scissors of claim 42, wherein the inner ring of the thumb loop and the inner ring of the finger loop are formed from a first plastic material.

49. The scissors of claim 48, wherein the first plastic material is one of an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), or a combination thereof.

50. The scissors of claim 48, wherein the first gripping element is at least partially overmolded on the first plastic material that forms the thumb loop; and
wherein the second gripping element and the third gripping element are at least partially overmolded on the first plastic material that forms the finger ring.

51. The scissors of claim 42, wherein the first gripping element, the second gripping element, and the third gripping element are made from a polymer material.

52. The scissors of claim 51, wherein the polymer material is a Natural Rubber (NR), a Styrene-butadiene rubber (SBR), a Butyl (IIR), a Nitrile (NBR), a Neoprene® (CR), an Ethylene Propylene Diene Monomer (EPDM), a Silicone (Q), a Viton® (FKM), a Polyurethane (AU), or a Hydrogenated Nitrile (HNBR).

53. The scissors of claim 50, wherein the first gripping element, the second gripping element, and the third gripping element are formed from a second plastic material.

54. The scissors of claim 53, wherein the second plastic material is a Thermoplastic Elastomer (TPE) or a Thermoplastic Rubber (TPR).

55. The scissors of claim 42, wherein the coupler is a tension knob, a dial, or a screw.

56. The scissors of claim 42, wherein the first blade has a cutting edge, and the second blade has a cutting edge.

57. The scissors of claim 56, wherein the cutting edge of the first blade includes a first plurality of teeth and the cutting edge of the second blade includes a second plurality of teeth.

58. The scissors of claim 42, wherein the inner ring of the thumb loop is tapered between the first side and the second side of the thumb loop such that an opening through the thumb loop is larger on the first side of the thumb loop than on the second side of the thumb loop.

59. The scissors of claim 58, wherein the inner ring of the thumb loop has an angled or a non-linear surface as the inner ring of the thumb loop extends between the first side and the second side of the thumb loop.
